(19) United States
(12) Patent Application Publication
(10) Pub. No.: US 2003/0014474 A1
(43) Pub. Date: Jan. 16, 2003

(54) Alternate zero overhead task change circuit

(76) Inventors: Ray S. McKaig, Vancouver, WA (US); James E. Howard, Portland, OR (US)

Correspondence Address: William O. Geny, Esq., Chernoff, Vilhauer, McClung & Stenzel, LLP, 1600 ODS Tower, 601 SW Second Avenue, Portland, OR, 97204-3157, US

(21) Appl. No.: 10/160,652

(22) Filed: May 30, 2002

Related U.S. Application Data
(60) Provisional application No. 60/294,692, filed on May 30, 2001.

(51) Int. Cl. G06F 7/38

(52) U.S. Cl. 709/108; 712/228

(57) ABSTRACT

A hardware task change system for the reduction of task change processing overhead delays in computer architectures includes an electronic circuit that switches data or tasks in multitasking computer architectures or other data processing circuits with minimal time delays. The system switches tasks by selecting the next task to run from the main working register set, the alternate register set, or the task storage memory. The working register has no multiplexer delay to the Central Processing Unit (CPU), and accomplishes this by connecting only one working register to the CPU instead of multiplexing two or more alternate working registers.

### CROSS-REFERENCE TO RELATED APPLICATIONS

This is a patent application under 35 U.S.C. §111(a) based upon U.S. Provisional Patent Application Serial No. 60/294,692 entitled ALTERNATE ZERO OVERHEAD TASK CHANGE CIRCUIT filed May 30, 2001.

### BACKGROUND OF THE INVENTION

In traditional state of the art computers, task switching instruction sequences result in extensive expenditures of time spent switching between tasks. The time spent between tasks is called the task change processing overhead. It is the time used for saving and restoring the registers and includes other delays such as the time used in determining task priorities and task execution justification. Thus, these periods of time become unavailable for useful processing. This interrupt and task change processing overhead amounts to tens or hundreds of cycles in many modern computers. Even at multi-Megahertz clock rates, the combination of latency delays and the time required for switching overhead results in computers that severely limit interrupt rates. Even the fastest modern computers are forced to rely on external hardware for processing multimedia data transfers and other interrupt events.

Often, interrupts remain disabled throughout the interrupting task processing cycle, thus further increasing interrupt latency for other interrupting tasks. When interrupts are reenabled during an interrupt task processing cycle, a particularly destructive problem may occur with program stack oriented processors where information is “pushed” onto a stack storage area to save processor states and registers. It is possible for interrupts that are nested within other interrupts routines to be accepted before the previous interrupting task reaches its completion, thus allowing repeated stack writes without permitting their associated reads to occur. These result in “stack overflows” which are capable of “crashing” a computer system by overwriting programs with stack data.

As a result of these time limitations in interrupt and task change latency and processing overhead, delays can be hundreds or even thousands of cycles long in modern complex computers. Modern applications require an ever greater number of interrupts which simply further aggravates the problem.

Conventional computer systems require extensive storage buffering and auxiliary specialized processors to accommodate high data rates in task switching circumstances. The addition of buffer memory and associated circuitry results in increased chip sizes, lower yields, increased energy requirements, higher operating temperatures, reduced processing performance levels and higher costs.

Multiple register interrupt and task switching systems all suffer various limitations. In particular, the use of large register sets causes a concomitant increase in wiring and capacitance related delays, slowing the entire computer. Other methods have used separate register stores for data storage, but this results in a waste of time during the movement of the data to and from these task saving registers before the execution of an interrupt. Then, additional time must be used to load the working data into the general purpose registers before interrupt processing can begin.

One solution to this problem is found in U.S. Pat. No. 5,987,601 owned by the assignee herein which is incorporated herein by reference. One problem with the circuit shown in the '601 patent is, however, the delay encountered through the output multiplexer (MUX) which couples alternate register latches to a central processing unit (“CPU”).

### BRIEF SUMMARY OF THE INVENTION

A task change circuit automatically switches tasks to be executed by a computer CPU or arithmetic logic unit (“ALU”). The circuit includes a working task register which has an output coupled to the CPU or ALU and contains a next task to be executed by the ALU. At least a second task register is provided which stores another preselected task. A plurality of tasks may be stored in a task memory unit. A task control and multiplexer selectively sends tasks to the working task register such that on a first clock cycle, the next task to be executed is sent from the working task register to the CPU and a subsequent task stored in the task memory or in the second task register is loaded into the working task register.

### BRIEF DESCRIPTION OF THE SEVERAL VIEWS OF THE DRAWINGS

FIG. 1 is a circuit diagram depicting the data path for the execution of the task in Register X, as it prepares the same task to execute the next cycle.

FIG. 2 is a circuit diagram depicting the data path for the execution of the task in Register X, as it prepares the task in Register Y to execute the next cycle.

FIG. 3 is a circuit diagram depicting the data path for the execution of the task in Register X, as it prepares the task from Task Memory to execute the next cycle.

FIG. 4 is a circuit diagram depicting the data path for writing the task from Task Memory to Register C for access by other tasks.

FIG. 5 is a circuit diagram depicting the data path for writing the task from Register C to Task Memory, thus preparing the task for execution.

FIG. 6 is a circuit diagram depicting the data path for the task in Register X to access data from Register C.

FIG. 7 is a circuit diagram depicting the data path for the task in Register X to write data to Register C.

FIG. 8 is a circuit diagram depicting an alternative to the use of Register C, where data from any one of a multitude of registers from tasks stored in Task Memory may be accessed by the task in Register X.

FIG. 9 is a circuit diagram depicting data paths used to accomplish zero overhead bus or registered hardware sharing with the registers of tasks in Registers X and Y, thus allowing direct access with Memory or external data (Input and Output).

### DESCRIPTION OF THE PREFERRED EMBODIMENT

The following descriptions and diagrams illustrate a preferred embodiment of a task switching circuit for the reduction or elimination of task change processing overhead delays. With little loss of time, the system performs complete task state saving and restoration between one execution cycle and the next. This permits switching tasks in such a manner so as to allow a continuous and uninterrupted flow of task executions. This capacity for switching tasks without loss of time thereby assures the maximum productive use of the microprocessor's CPU in all task switching situations. Each diagram depicts data flow paths for the execution, storage, and the retrieval of data from one location to another within a single processing cycle.

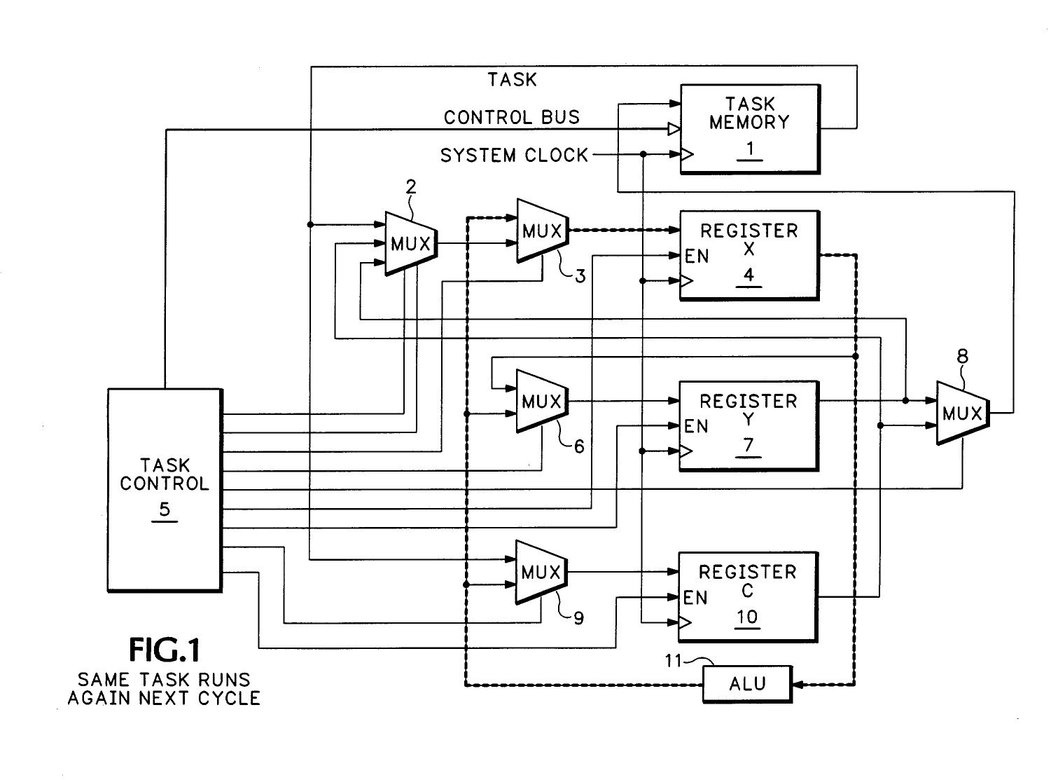

In FIGS. 1-7, running tasks are located in Register X 4 and data is processed through the Arithmetic Logic Unit (ALU) or directly routed to Register Y 7 or other places. It should be understood that the circuit of FIGS. 1-9 is usable with any CPU or portion thereof for executing coded tasks and that an ALU is provided herein merely as an example of such an execution unit. Note that Registers X 4, Y 7, and C 10 may consist of multiple registers if so required, and that not all parts of the registers need be written with new data. Typically a task is executing from Register X 4 whether or not the data paths for its execution are shown in the diagrams. The diagrams depict the path of data to be manipulated or stored. Note also that Task Memory 1 is able to store and retrieve all register data for all tasks.

As depicted in FIGS. 1-8, an active task may reside in only one place at a time: Register X 4, Register Y 7, or in Task Memory 1. Task Control 5 is responsible for the selection of various data paths required for the various circuit functions. The selection process may operate in a manner similar to that disclosed in the aforementioned U.S. Pat. No. 5,987,601. For the purpose of the following descriptions, tasks consist of register data and control information, which are all considered data.

Common to all figures, a set of registers 4, 7, and 10 respectively, is connected to input MUX's 3, 6, and 9. Registers Y 7 and C 10 have outputs connected to MUX 8 that is in turn coupled to task memory 1. Register X 4 is the “working register” in that the next task to run is always loaded through this register directly to the ALU 11. It has no output MUX. A task control circuit 5 is coupled to the task memory 1 via a control bus. Task control 5 is connected to the “select” pins of all MUX's including MUX 2 which has an output coupled to MUX 3. The task control circuit 5 is also coupled to the “enable” pins of registers 4, 7, and 10 and a system clock is connected to the clock inputs of all registers and the task memory 1. The ALU 11 is chosen as an example of a processor function for use with the system. A CPU or other task execution unit could also be used.

In FIG. 1, the task to execute in the next execution cycle is the same task currently executing, therefore data initiating in working Register X 4 is sent through the ALU 11 for possible processing, routed through MUX 3, and back to Register X 4 completing the execution cycle. The data route of this task is illustrated as a dotted line overlay on the circuit path.

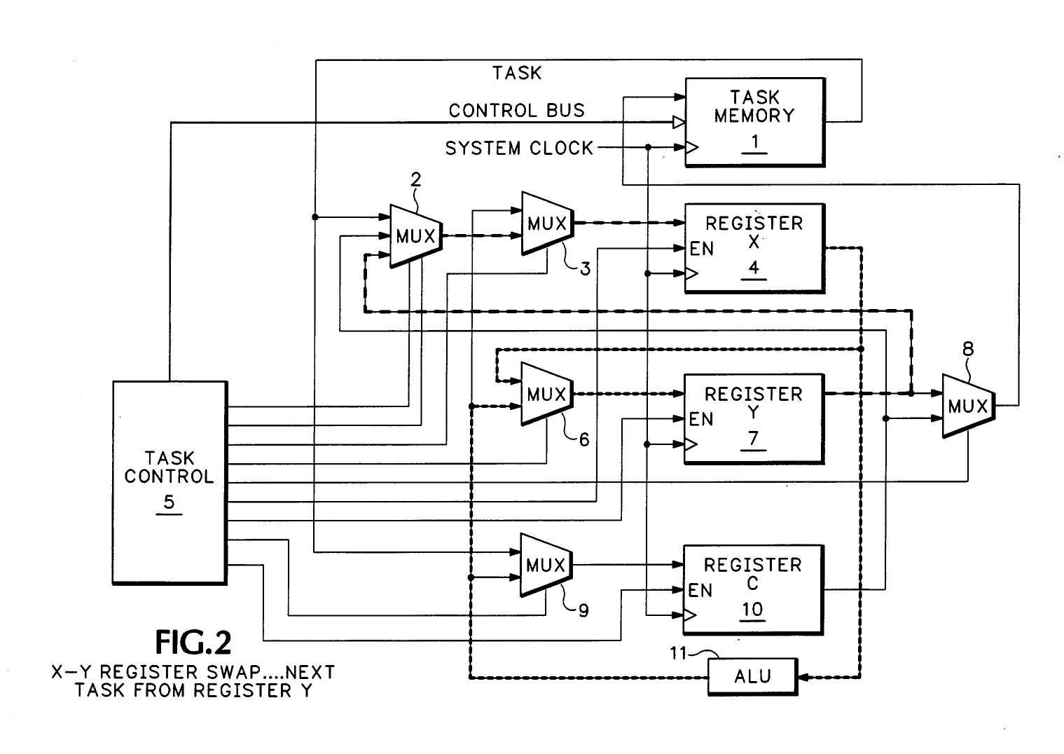

In FIG. 2, the next task to execute resides in Register Y 7 and must first be sent to Register X 4, the working register. Its path is illustrated as a dashed line overlay. Therefore, the current task running in Register X 4 processes data which is latched in Register Y 7 via ALU 11 and MUX 6, while all other Register X 4 data is also routed directly to Register Y 7 through MUX 6. Concurrently, the next task in Register Y 7 is transferred to Register X 4 via MUX 2 and MUX 3 in preparation to execute the next processing cycle.

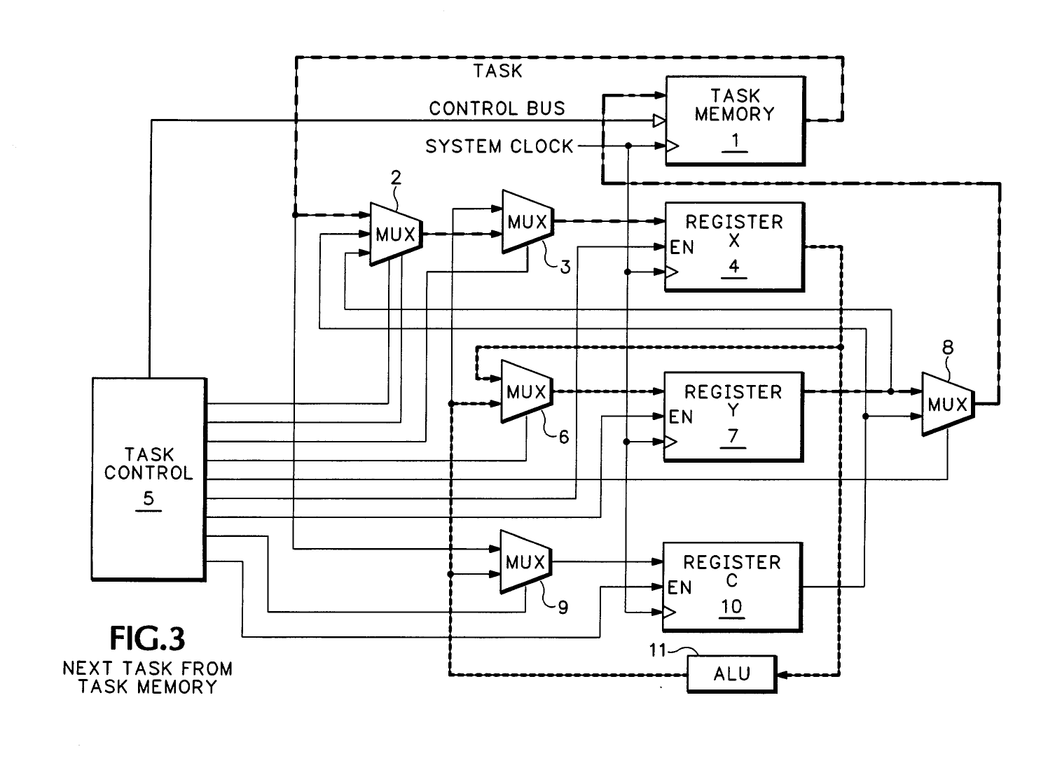

In FIG. 3, Task Memory 1 holds the next task to run. Similar to the above description for FIG. 2, the current task running in Register X 4 has its ALU 11 processed data and all other Register X 4 data routed to Register Y 7 through MUX 6, but this time the next task to run is routed from Task Memory 1 to Register X 4 via MUX 2 and MUX 3. If a task already resides in Register Y 7, it is concurrently saved into Task Memory 1 via MUX 8. Its path is illustrated as the dash-dot line overlay.

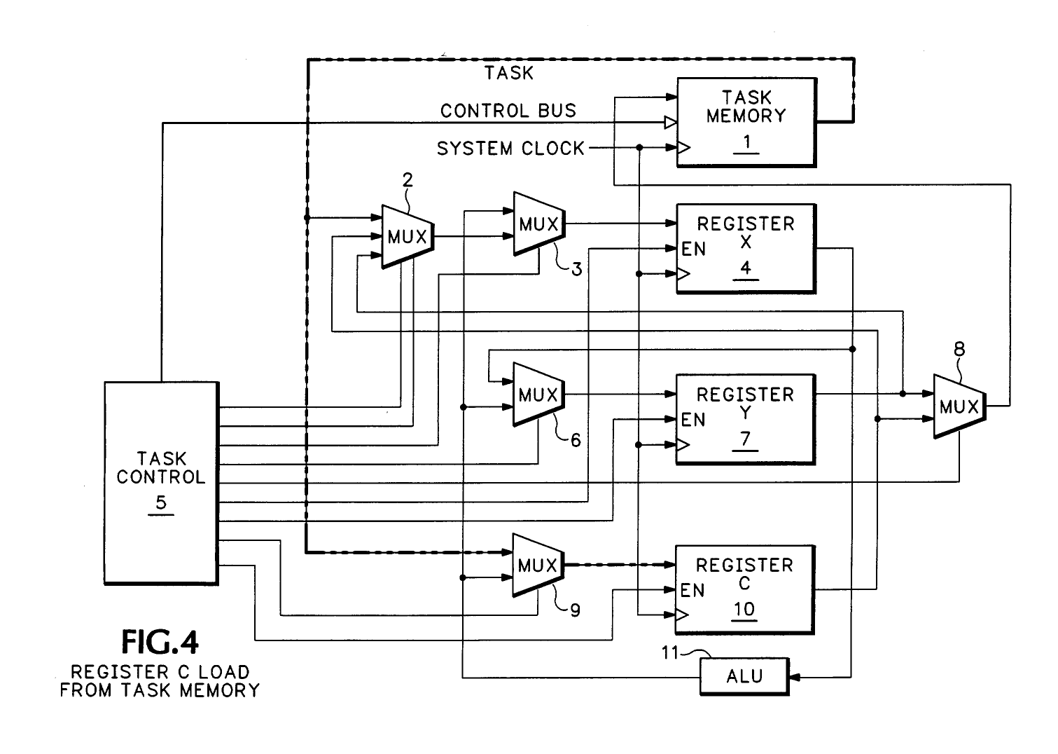

In order to provide a mechanism to load, download, and monitor any task's data, a separate register can be accessed and controlled by another task, preferably a system monitor task. Register C 10 provides this functionality as illustrated in FIGS. 4-7. The use of Register C 10 assumes that task processing from Register X 4 concurrently occurs as described above.

FIG. 4 illustrates the path shown as a double-dot-dash line overlay from Task Memory 1 to Register C 10 via MUX 9.

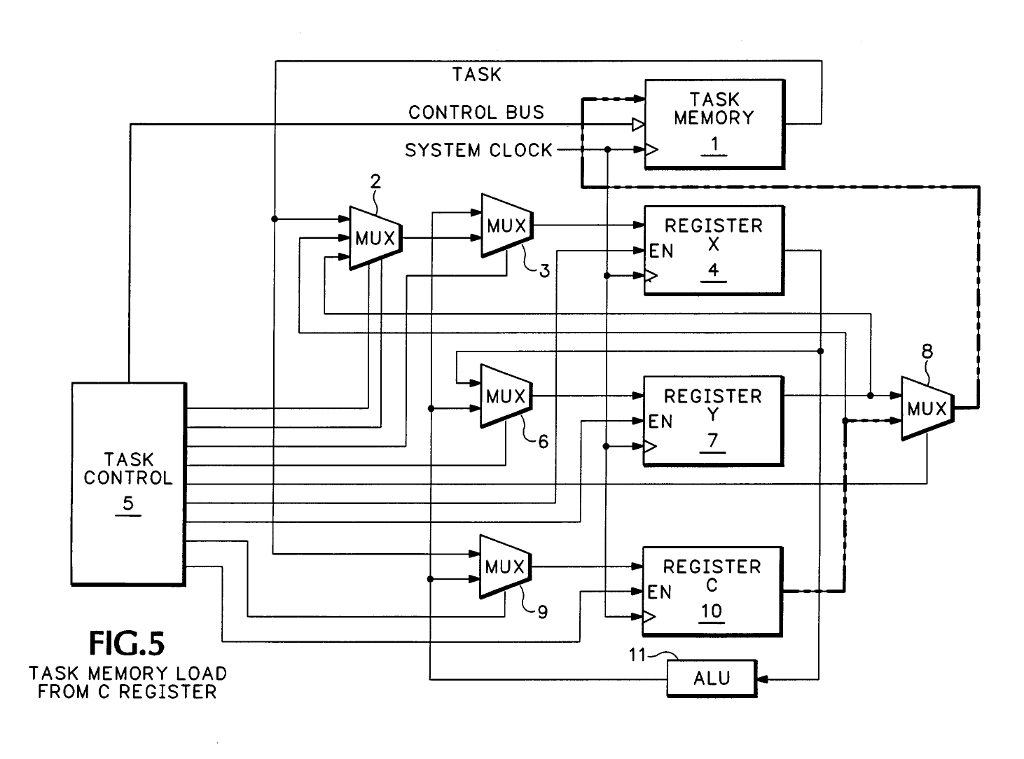

FIG. 5 illustrates the path shown as a double-dot-dash line overlay from Register C 10 to Task Memory 1 via MUX 8.

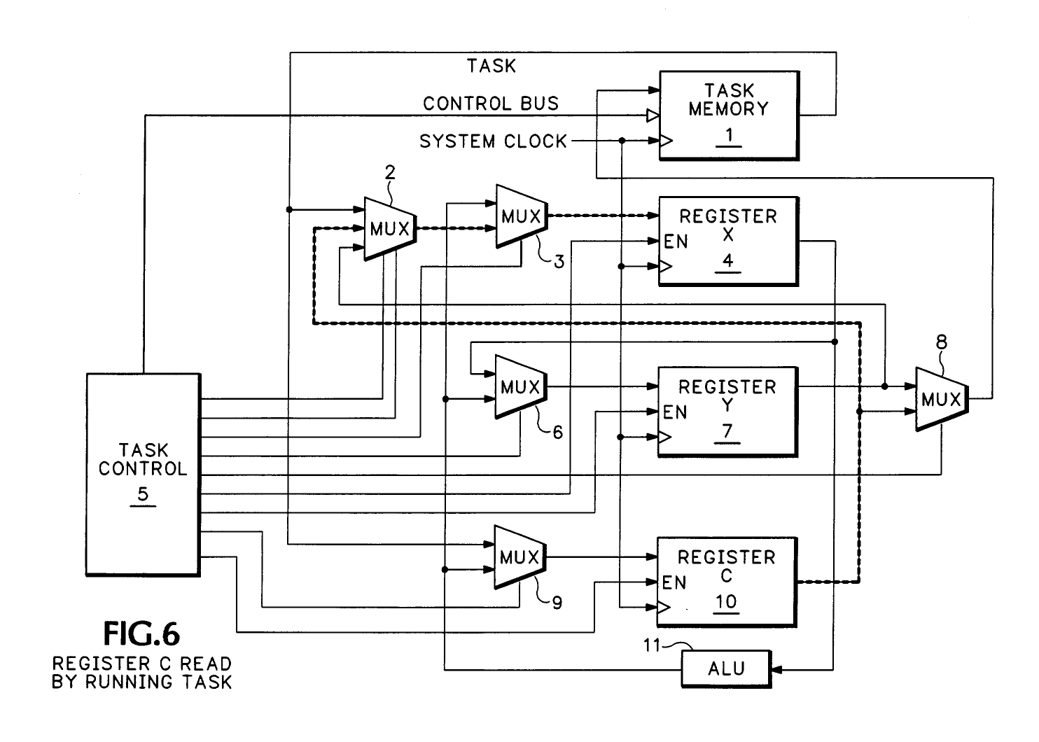

FIG. 6 illustrates the path from Register C 10 to the working task in Register X 4 via MUX 2 and MUX 3. The current task in Register X 4 must also execute the next processing cycle since a next task cannot be loaded while data from Register C 10 is being read into Register X 4.

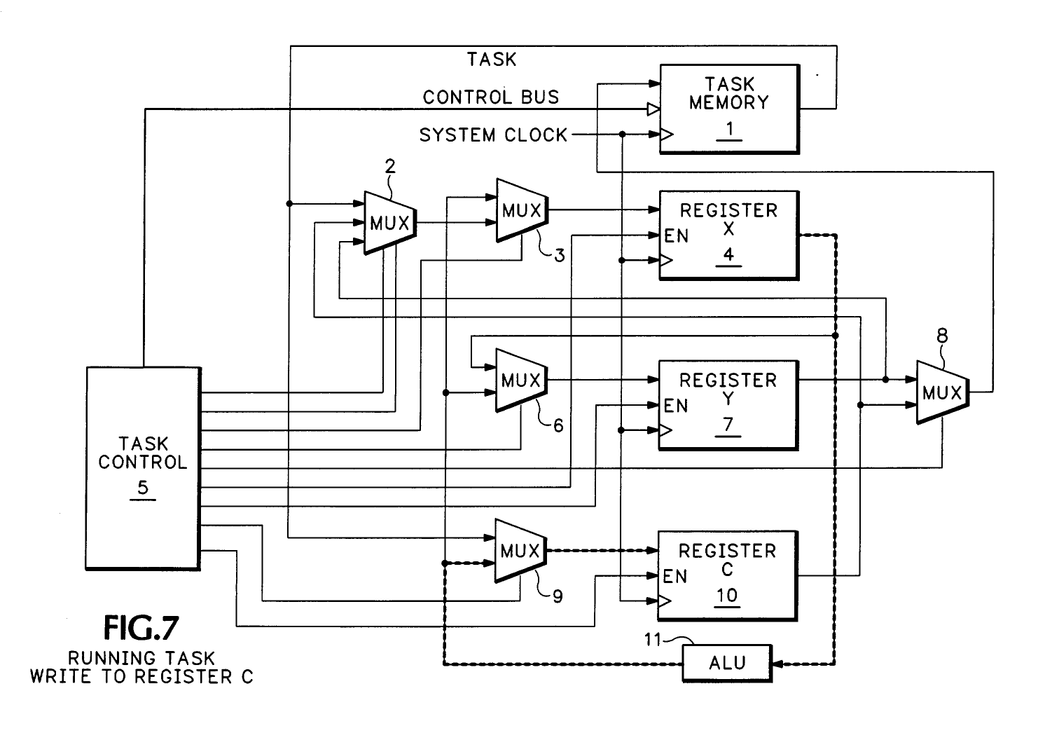

FIG. 7 illustrates the path from the working task in Register X 4 to Register C 10 via ALU 11 and MUX 9.

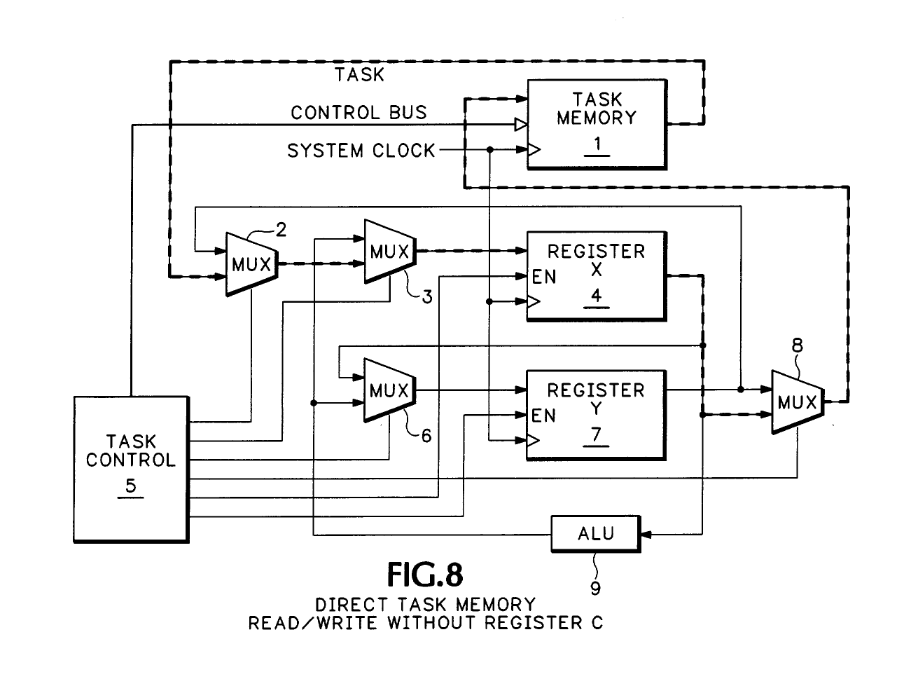

FIG. 8 illustrates an alternative circuit to access registers from other tasks. Any task's registers may be read directly from Task Memory 1 to Register X 4 through MUX 2 and MUX 3. Task Memory 1 may also be written directly from Register X 4 via MUX 8. In using this circuit, specific registers are selected for access from the multitude of registers in Task Memory 1.

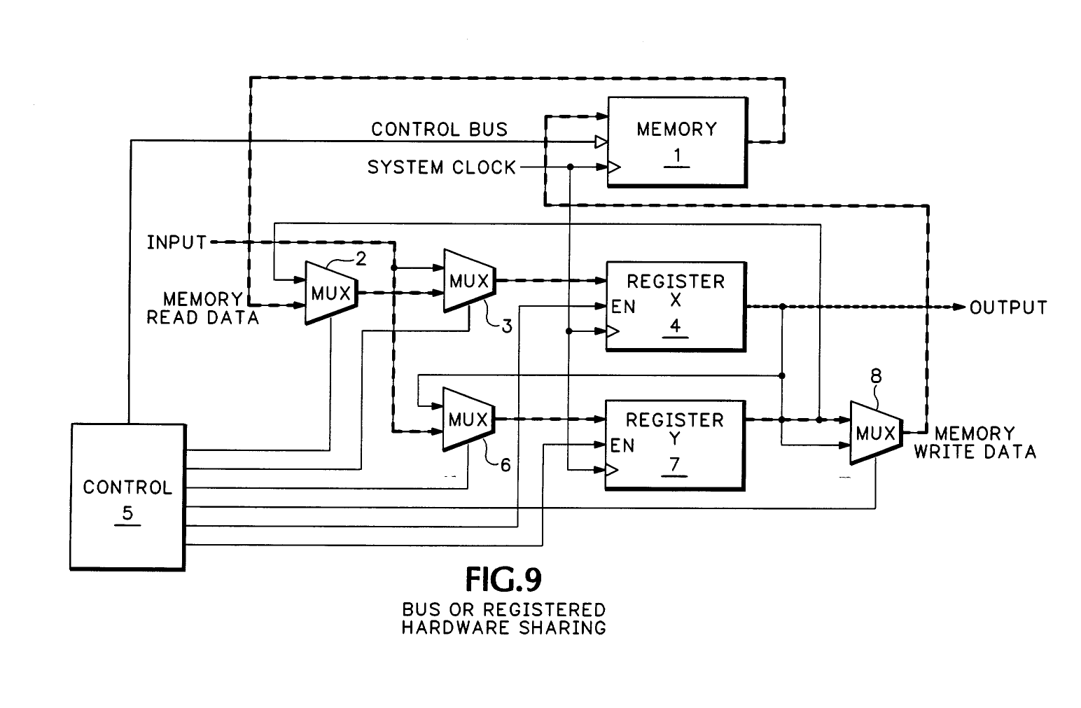

FIG. 9 illustrates zero overhead bus or registered hardware sharing. The task switching circuitry may be manipulated by task control 5 to allow simultaneous data transfers from task memory 1 to Register X 4 via MUX 2 and MUX 3, from Register X 4 to the Output bus, from the Input bus to Register Y 7 via MUX 6, and from Register Y 7 to Memory 1 via MUX 8.

While various embodiments of the present invention have been described above, it should be understood that they have been presented by way of example, and not limitation. Thus, the breadth and scope of the present invention should not be limited by any of the above described exemplary embodiments, but should be defined only in accordance with the following claims and their equivalents. It will be understood by those skilled in the art that various changes in form and detail may be made therein without departing from the spirit and scope of the invention.

The terms and expressions employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims that follow.

I claim:

1. A task change circuit for switching tasks to be executed by a computer task execution unit:
(a) a working task register having an output coupled to said task execution unit and containing a first task to be executed by said task execution unit;
(b) at least one second task register for storing a preselected next task; and
(c) task control and multiplexer means for selectively storing tasks in said working task register and in said second task register wherein, on a first clock cycle, said first task is executed by said task execution unit and said preselected next task is stored in said working task register for execution on a next clock cycle.

2. The task change circuit of claim 1 further including a task storage memory unit coupled to said second task register through an output multiplexer.

3. The task change circuit of claim 2 further including a third task register coupled to said output multiplexer.

4. The task change circuit of claim 3 wherein said task control and multiplexer means includes an input multiplexer coupled to said working task register, said input multiplexer having inputs from said task memory storage and at least one of said second and third task registers.

5. A task change circuit for switching tasks to be executed by a computer task execution unit comprising:
(a) a working task register having an output coupled to said computer task execution unit and containing a first task to be executed by said computer task execution unit;
(b) a second task register for storing a preselected task;
(c) a task memory storage;
(d) said working task register having an input multiplexer network coupled to said second task register and to said task memory storage; and
(e) a task control circuit coupled to said multiplexer network for selecting a subsequent task to run from either said second task register or said task memory storage unit.

6. The task change circuit of claim 5 further including a third task register having an output coupled to said input multiplexer network.

7. A task switching network for automating the switching of tasks into a computer task execution unit in a microprocessor based data processing system comprising:
(a) a working task register having an output coupled to said computer task execution unit;
(b) at least one secondary task register for temporarily storing a preselected task;
(c) a task memory for storing a plurality of preselected tasks;
(d) an input multiplexing network for switching tasks into said working task register from said secondary register and from said task memory unit;
(e) an output multiplexer coupling said secondary task register to said task memory unit; and
(f) a task control circuit controlling the input multiplexing network and the output multiplexer for selectively switching tasks stored in said second task register and in said task memory to said working task register for execution by said computer task execution unit.
